(19) United States
(12) Patent Application Publication
(10) Pub. No.: US 2025/0016439 A1
(43) Pub. Date: Jan. 9, 2025

(54) CONFERENCING SYSTEMS AND METHODS FOR ADJUSTING CAMERA TRACKING BASED ON MICROPHONE COVERAGE

(71) Applicant: Shure Acquisition Holdings, Inc., Niles, IL (US)

(72) Inventors: Bijal Joshi, Elk Grove Village, IL (US); Douglas Daube, Des Plaines, IL (US)

(21) Appl. No.: 18/763,953

(22) Filed: Jul. 3, 2024

Related U.S. Application Data
(60) Provisional application No. 63/512,500, filed on Jul. 7, 2023.
(60) Provisional application No. 63/604,448, filed on Nov. 30, 2023.

(51) Int. Cl. H04N 23/60; H04L 12/18; H04N 23/62; H04N 23/69; H04N 23/90; H04R 1/40; H04R 3/00

(52) U.S. Cl. CPC H04N 23/64; H04L 12/1827; H04N 23/62; H04N 23/69; H04N 23/90; H04R 1/406; H04R 3/005

(57) ABSTRACT

Conferencing systems and methods configured to more accurately and optimally position cameras towards a talker are disclosed. The positioning of cameras may be based on the coverage area of microphone arrays in an environment and through the use of error regions surrounding camera presets.

### CROSS-REFERENCE

This application claims the benefit of U.S. Provisional Patent Application No. 63/512,500, filed on Jul. 7, 2023, and U.S. Provisional Patent Application No. 63/604,448, filed on Nov. 30, 2023, both of which are fully incorporated by reference in their entirety herein.

### TECHNICAL FIELD

This application generally relates to adjusting camera tracking of talkers in a conferencing environment, and more specifically, to conferencing systems and methods for more accurate and optimal positioning of a camera towards a talker based on the coverage area of a microphone in the conferencing environment and through the use of error regions surrounding camera presets.

### BACKGROUND

Conferencing environments, such as conference rooms, boardrooms, video conferencing settings, and the like, can involve the use of microphones (including microphone arrays) for capturing sound from audio sources in the environment (also known as a near end) and loudspeakers for presenting audio from a remote location (also known as a far end). For example, persons in a conference room may be conducting a conference call with persons at a remote location. Typically, speech and sound from the conference room may be captured by microphones and transmitted to the remote location, while speech and sound from the remote location may be received and played on loudspeakers in the conference room. Multiple microphones may be used in order to optimally capture the speech and sound in the conference room.

Such conferencing environments may also include one or more image capture devices, such as cameras, which can be used to capture and provide images and/or video of persons and objects in the environment to be transmitted for viewing at the remote location. However, it may be difficult for the viewers at the remote location to see particular talkers if, for example, the camera in an environment is configured to only show the entire room or if the camera is fixed to show only a specific pre-configured portion of the room and the talkers move in and out of that portion during a meeting or event. Talkers may include, for example, humans in the environment that are speaking or making other sounds.

In addition, in environments where multiple cameras and/or multiple microphones are desirable for adequate video and audio coverage, it may be difficult to accurately determine the location of a talker in the environment and/or to identify which of the cameras should be directed towards the talker. For example, the location of a talker determined by the microphone may be utilized to select a camera to point at the talker, based on comparing the location of the talker to a preset for the camera. However, the microphone may not always precisely determine the location of the talker, which can result in the selection and use of a non-optimal camera, even if the location of the talker is actually at a preset for a more optimal camera, e.g., a camera that has a better angle to zoom in on the talker. This scenario can occur when an inaccurate location of the talker is utilized and determined to not be at the preset for the more optimal camera, for example.

### SUMMARY

The techniques of this disclosure are directed to solving the above-noted problems by providing systems and methods that are designed to, among other things: (1) generating error regions associated with camera presets to compensate for inaccurate determinations of the locations of talkers by a microphone; (2) adjusting the error regions associated with camera presets based on distances between microphones and the camera presets, and/or based on the alignments of cameras with microphones; and (3) selecting a camera for capturing the image of a talker based on the location of the talker and the error region associated with a camera preset.

In an embodiment, a method includes receiving a location of a camera preset; determining a camera of a conferencing system to be associated with the location of the camera preset, based on the location of the camera preset, a location of a microphone, and a location of the camera; determining an error region associated with the camera preset, based on the location of the camera preset, the location of the microphone, and a coverage area of the microphone; and storing the error region associated with the camera preset.

In another embodiment, a method includes retrieving a stored error region associated with a camera preset; determining, using a microphone and based on audio associated with a talker, a location of the talker; selecting, based on the location of the talker and the error region associated with a camera preset, a camera for capturing an image of the talker; and transmitting the location of the talker to the camera to cause the camera to point towards the location of the talker.

In a further embodiment, a system includes a plurality of microphones, where each of the plurality of microphones has a location and a coverage area; a plurality of cameras, where each of the plurality of cameras has a location; and one or more processors in communication with the plurality of microphones and the plurality of cameras. Any of the one or more processors is configured to: determine one of the plurality of cameras to be associated with a camera preset, based on: the location of the camera preset, the location of one of the plurality of microphones, and the location of the one of the plurality of cameras; determine an error region associated with the camera preset, based on: the location of the camera preset, the location of the one of the plurality of microphones, and the coverage area of the one of the plurality of microphones; and when a location of a talker is determined to be within the error region associated with the camera preset, select and control the one of the plurality of cameras to capture an image of the talker.

These and other embodiments, and various permutations and aspects, will become apparent and be more fully understood from the following detailed description and accompanying drawings, which set forth illustrative embodiments that are indicative of the various ways in which the principles of the invention may be employed.

### BRIEF DESCRIPTION OF THE DRAWINGS

FIG. 1 is a block diagram of a conferencing system with multiple microphone arrays and multiple cameras, where the microphones detect the locations of talkers to direct the cameras to capture images and video of the talkers, in accordance with some embodiments.

FIG. 2 is a block diagram of a microphone array configured for automated detection of audio activity that is usable in the system of FIG. 1, in accordance with some embodiments.

FIGS. 3A-3D are exemplary top-down depictions of a conferencing environment that shows microphones, cameras, and camera presets, in accordance with some embodiments.

FIG. 4 is a flowchart illustrating operations for configuring camera presets and generating error regions associated with the camera presets in a conferencing environment, in accordance with some embodiments.

FIG. 5 is an exemplary top-down depiction of a conferencing environment that shows microphones, cameras, and inclusion zones, and that can be used for the automated camera tracking of talkers, in accordance with some embodiments.

FIGS. 6A-6B are exemplary top-down depictions of a conferencing environment that shows microphones, cameras, camera presets, and inclusion zones, and that can be used for the automated camera tracking of talkers, in accordance with some embodiments.

FIG. 7 is a flowchart illustrating operations for the automated tracking of talkers in a conferencing environment based on the locations of talkers, camera presets, error regions associated with the camera presets, and/or inclusion zones, in accordance with some embodiments.

### DETAILED DESCRIPTION

The systems and methods described herein can improve the configuration and usage of conferencing systems by generating error regions around camera presets, based on the relative position of the camera presets with respect to a microphone array. In this way, the audio localization information determined by the microphone array (or a microphone) can more optimally select and configure cameras to capture the images of talkers in an environment. For example, a microphone can detect a location of a talker in the environment using an audio localization algorithm and provide the detected talker location to a camera, a camera controller, and/or an aggregator so that a particular camera can be selected and pointed towards the talker based on a camera configuration that is optimal to the error region provided by the microphone array for the location of the camera in the environment with respect to the location of the microphone array and the location of the talker.

A camera preset may include a particular location in the environment that can be configured by a user, for example. The camera preset may correspond to specific views of the camera, such as a view of a particular location and/or a zoom setting that would capture a particular portion of the environment. The camera presets may include particular settings for angle, tilt, zoom, and/or framing of images and/or video captured by the camera. The settings may be optimally configured based on the location of the camera, the location of the microphone array, and the location of the camera presets with respect to the camera and the microphone array.

Audio localization information typically contains azimuth, elevation, and radius coordinates representing an estimated location of the talker or other audio source relative to the microphone. While the azimuth and elevation aspects of the localization information are often relatively accurate estimates, the localization information related to the radius may not be perfectly precise due to various factors, including limited angle of arrival resolution, uncertainties due to room reverberation, possible skew due to various room noises, and more. These acoustic variations may also impact the measurements of the azimuth and elevation at a different rate, as compared to the radius. As such, the location of talkers detected by microphones may not be properly determined to be at the location of a camera preset associated with an optimal camera, which can result in the selection of a non-optimal camera rather than the optimal camera.

The systems and methods described herein can generate error regions with respect to the microphone array for a determined region that can be associated with camera presets, in order to compensate for the imprecise locations of talkers detected by microphones. The error regions may be areas surrounding the position of a talker at camera presets, and can be adjusted based on various parameters, such as the acoustics of the room, the placement of furniture and other objects in the room, the distance between a microphone and the camera preset and/or the alignment of a camera with a microphone. As such, when a location of a talker detected by a microphone is within an error region for a particular camera preset, the camera associated with that particular camera preset can be configured as if the location of the talker is at the preset location of the particular camera.

The locations of talkers can be provided to the camera, camera controller, and/or an aggregator so that the camera can be pointed to capture an image or video of the talker. The camera can utilize the received talker location for moving, zooming, panning, framing, or otherwise adjusting the image and video captured by the camera. In this way, the systems and methods described herein can take into account an error region to determine the area in which a camera should be focusing, and can therefore be used by the conferencing system to enable the camera to more accurately configure and capture an image and/or video of an active talker, for example. In embodiments, a camera artificial intelligence system can be utilized with the systems and methods described herein to focus within a narrower region and further refine the locations of talkers.

As used herein, the terms “lobe” and “microphone lobe” refer to an audio beam generated by a given microphone array (or array microphone) to pick up audio signals at a select location, such as the location towards which the lobe is directed. While the techniques disclosed herein are described with reference to microphone lobes generated by array microphones, the same or similar techniques may be utilized with other forms or types of microphone coverage (e.g., a cardioid pattern, etc.) and/or with microphones that are not array microphones (e.g., a handheld microphone, boundary microphone, lavalier microphones, etc.). Thus, the term “lobe” is intended to cover any type of audio beam or coverage.

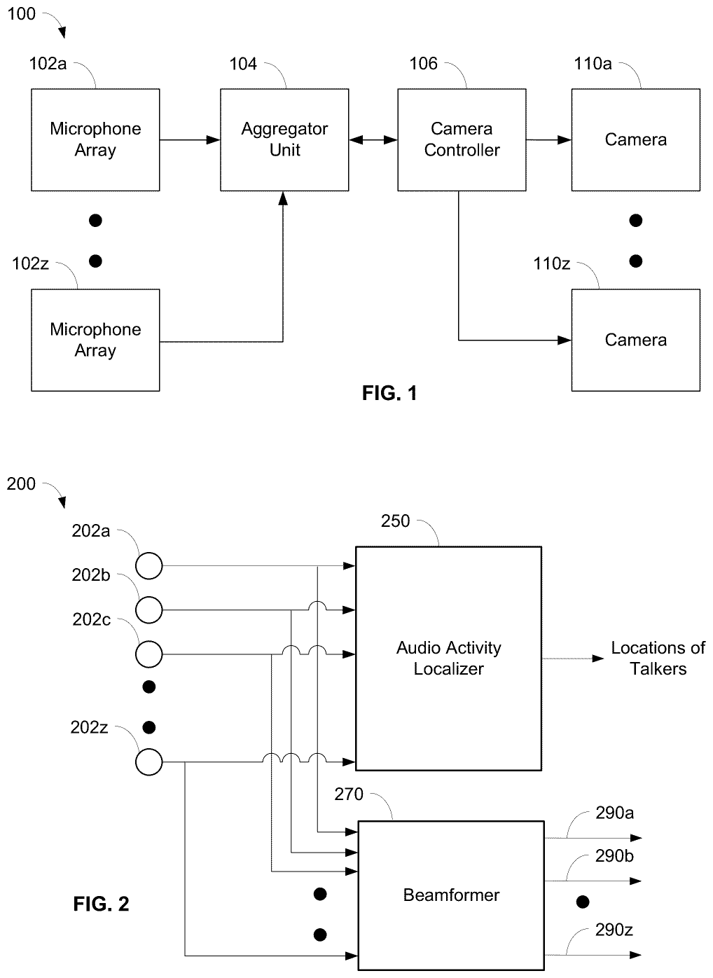

FIG. 1 shows a block diagram of a conferencing system 100 that includes one or more microphone arrays 102a, . . . , z that can detect the locations of objects and talkers in an environment, as well as an aggregator unit 104 that can receive the locations from the microphone arrays 102a, . . . , z and provide the locations to a camera controller 106 for positioning one or more cameras 110a, . . . , z. The camera controller 106 may select which of the cameras 110a, . . . , z to utilize for capturing images and/or video of a particular location, e.g., where an active talker is located. The selection by the camera controller 106 of the camera 110a, . . . , z to utilize may be based on one or more received locations of a talker, for example. The camera controller 106 may provide appropriate signals to the cameras 110a, . . . , z to cause the cameras 110a, . . . , z to move and/or zoom, for example. In some embodiments, the camera controller 106 and one or more of the cameras 110a, . . . , z may be integrated together. In other embodiments, the camera controller 106 can be part of one or more microphone arrays 102a, . . . , z and/or the aggregator unit 104. The components of the system 100 may be in wired and/or wireless communication with the other components of the system 100. The environment where the conferencing system 100 is located may include, for example, a conference room, office, huddle room, theatre, arena, music venue, etc.

The microphone arrays 102a, . . . , z may detect and capture sounds from audio sources within an environment, including talkers. The microphone arrays 102a, . . . , z may be capable of forming one or more pickup patterns with lobes that can be steered to sense audio in particular locations within the environment. The microphone arrays 102a, . . . , z may communicate with the camera controller 106 and/or the cameras 110a, . . . , z via a suitable application programming interface (API).

The cameras 110a, . . . , z may capture still images and/or video of the environment where the conferencing system 100 is located. In some embodiments, any of the cameras 110a, . . . , z may be a standalone camera, and in other embodiments, any of the cameras 110a, . . . , z may be a component of an electronic device, e.g., smartphone, tablet, etc. Any of the cameras 110a, . . . , z may be a pan-tilt-zoom (PTZ) camera that can physically move and zoom to capture desired images and video, or may be a virtual PTZ camera that can digitally crop and zoom images and videos into one or more desired portions.

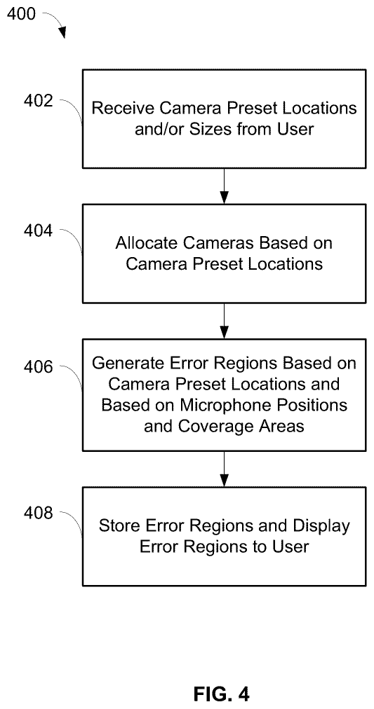

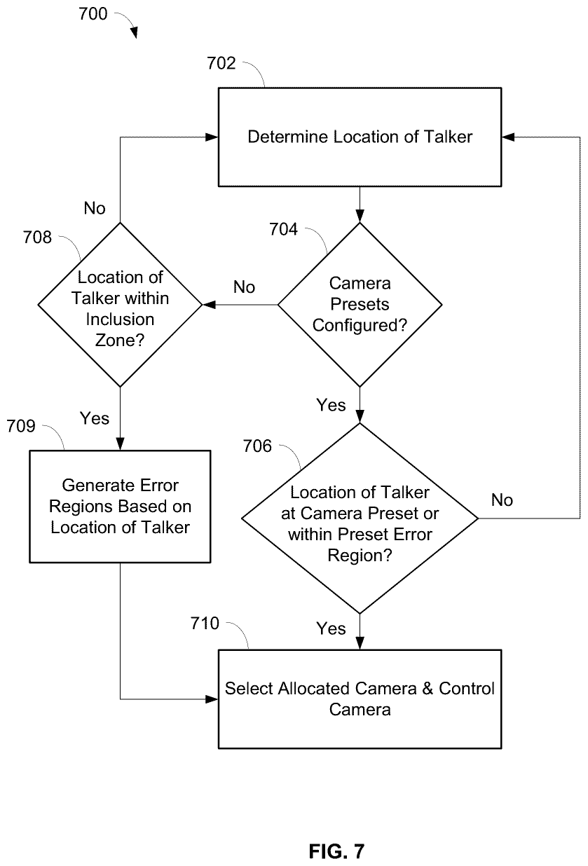

Some or all of the components of the conferencing system 100 may be implemented using software executable by one or more computers, such as a computing device having a processor and memory (e.g., a personal computer (PC), a laptop, a tablet, a mobile device, a smart device, thin client, etc.), and/or by hardware (e.g., discrete logic circuits, application specific integrated circuits (ASIC), programmable gate arrays (PGA), field programmable gate arrays (FPGA), digital signal processors (DSP), microprocessor, etc.). For example, some or all components of the conferencing system 100 may be implemented using discrete circuitry devices and/or using one or more processors (e.g., audio processor and/or digital signal processor) executing program code stored in a memory (not shown), the program code being configured to carry out one or more processes or operations described herein, such as, for example, the methods shown in FIGS. 4 and 7. Thus, in embodiments, the conferencing system 100 may include one or more processors, memory devices, computing devices, and/or other hardware components not shown in FIG. 1. It should be understood that the components shown in FIG. 1 are merely exemplary, and that any number, type, and placement of the various components of the conferencing system 100 are contemplated and possible.

FIG. 2 shows a block diagram of a microphone array 200, such as any of the microphone arrays 102a, . . . , z of FIG. 1, that is usable in the conferencing system 100 of FIG. 1 for detecting sounds from audio sources in an environment. The microphone array 200 may include any number of microphone elements 202a, b, c, . . . , z, for example, and be able to form one or more pickup patterns with lobes so that the sound from the audio sources can be detected and captured. Each of the microphone elements 202a, b, c, . . . , z in the microphone array 200 may detect sound and convert the sound to an analog audio signal. The microphone array 200 may also include an audio activity localizer 250 in wired or wireless communication with the microphone elements 202a, b, c, . . . , z, and a beamformer 270 in wired or wireless communication with the microphone elements 202a, b, c, . . . , z.

The microphone elements 202a, b, c, . . . , z may each be a MEMS (micro-electrical mechanical system) microphone with an omnidirectional pickup pattern, in some embodiments. In other embodiments, the microphone elements 202a, b, c, . . . , z may have other pickup patterns and/or may be electret condenser microphones, dynamic microphones, ribbon microphones, piezoelectric microphones, and/or other types of microphones. In embodiments, the microphone elements 202a, b, c, . . . , z may be arrayed in one dimension or multiple dimensions.

Other components in the microphone array 200, such as analog to digital converters, processors, and/or other components (not shown), may process the analog audio signals and ultimately generate one or more digital audio output signals. The digital audio output signals may conform to suitable standards and/or transmission protocols for transmitting audio. In embodiments, each of the microphone elements in the microphone array 200 may detect sound and convert the sound to a digital audio signal.

One or more digital audio output signals 290a, b, . . . , z may be generated corresponding to each of the pickup patterns. The pickup patterns may be composed of one or more lobes, e.g., main, side, and back lobes, and/or one or more nulls. The pickup patterns that can be formed by the microphone array 200 may be dependent on the type of beamformer used with the microphone elements, such as beamformer 270. For example, a delay and sum beamformer may form a frequency-dependent pickup pattern based on its filter structure and the layout geometry of the microphone elements. As another example, a differential beamformer may form a cardioid, subcardioid, supercardioid, hypercardioid, or bidirectional pickup pattern.

The audio activity localizer 250 may determine the location of audio activity in an environment based on the audio signals from the microphone elements 202a, b, c, . . . , z. In embodiments, the audio activity localizer 250 may utilize a Steered-Response Power Phase Transform (SRP-PHAT) algorithm, a Generalized Cross Correlation Phase Transform (GCC-PHAT) algorithm, a time of arrival (TOA)-based algorithm, a time difference of arrival (TDOA)-based algorithm, or another suitable sound source localization algorithm. The audio activity that is detected may include audio sources, such as human talkers. The location of the audio activity may be indicated by a set of three-dimensional coordinates relative to the location of the microphone array 200, such as in Cartesian coordinates (i.e., x, y, z), or in spherical coordinates (i.e., radial distance/magnitude r, elevation angle θ (theta), azimuthal angle φ (phi)). It should be noted that Cartesian coordinates may be readily converted to spherical coordinates, and vice versa, as needed. In embodiments, the audio activity localizer 250 may be included in the microphone array 200, may be included in another component, or may be a standalone component.

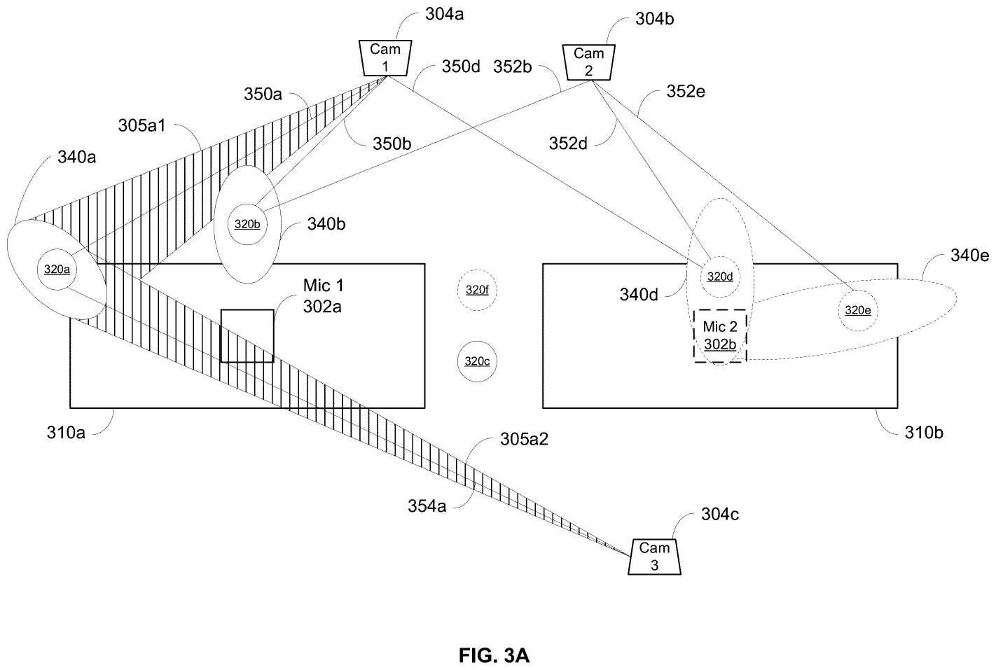

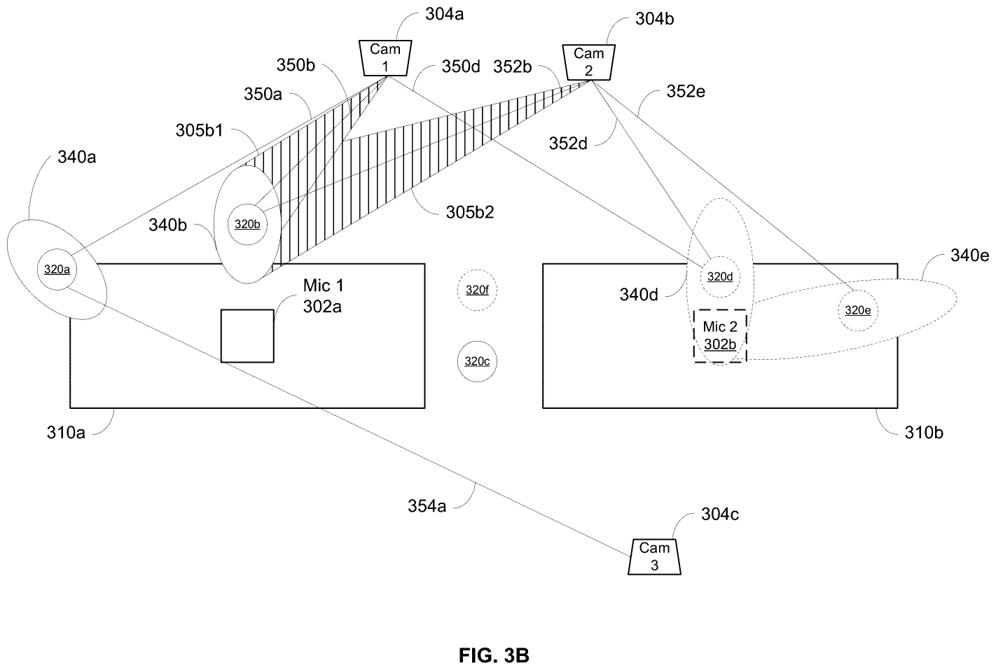

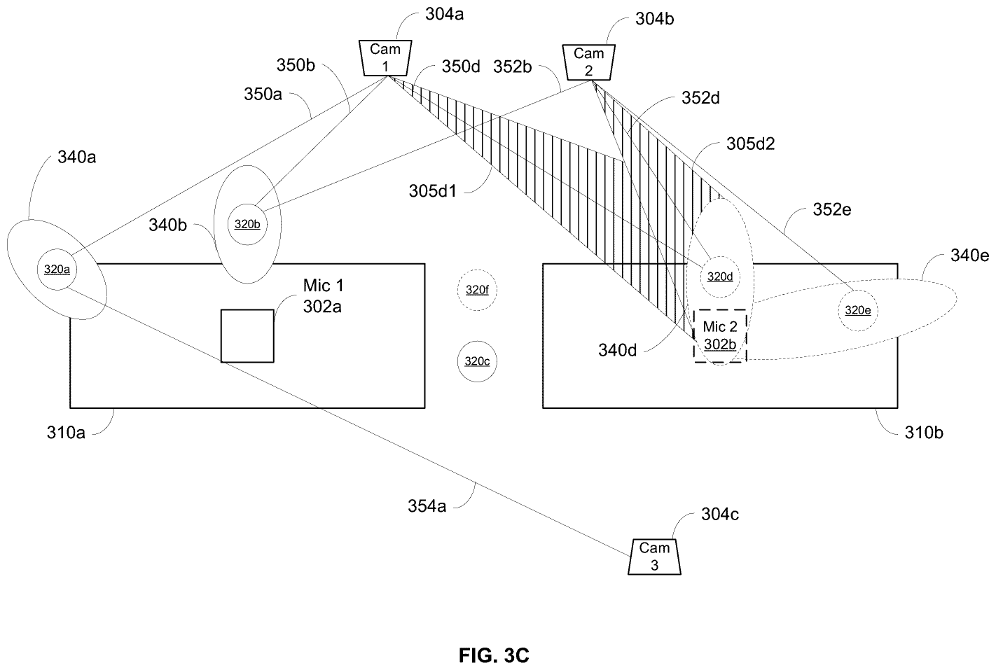

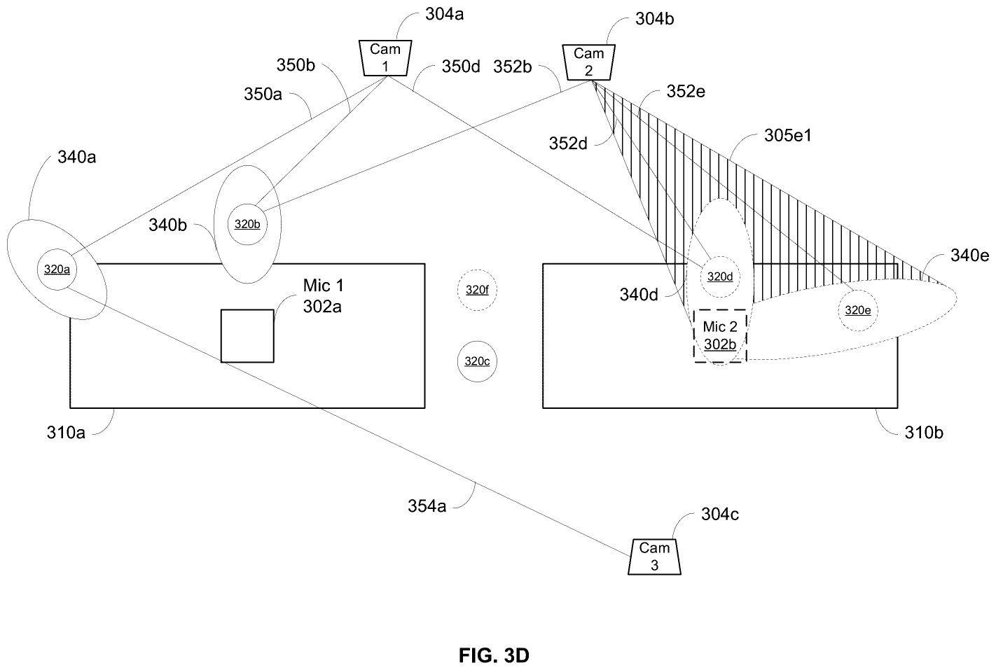

FIGS. 3A-3D are exemplary top-down depictions of an environment in which the system and methods disclosed herein may be used. In particular, each of FIGS. 3A-3D show an environment including two microphone arrays 302a, 302b (e.g., microphone array 200) and three cameras 304a, 304b, 304c. The environment shown in FIGS. 3A-3D also includes two tables 310a and 310b that could be located in a conference room and around which talkers may typically be seated, for example. As a non-limiting example, the microphone arrays 302a, 302b may be located on the ceiling of the room, and the cameras 304a, 304b, 304c may be located on the walls of the room. The use of multiple microphone arrays 302a and 302b may improve the sensing and capture of sounds from audio sources in the environment, while the use of multiple cameras 304a, 304b, 304c may enable the capture of more and varied types of images and/or video of the environment. For example, certain cameras 304a, 304b, 304c may be utilized to capture wider views of the environment, close-ups of talkers, etc.

It should be noted that in FIGS. 3A-3D, the microphone array 302a, the camera presets 320a, 320b, 320c that are associated with the microphone array 302a, and the error regions 340a, 340b that are associated with the camera presets 320a, 320b are each shown outlined in solid lines to denote their relationships to one another. In addition, the microphone array 302b, the camera presets 320d, 320e, 320f that are associated with the microphone array 302b, and the error regions 340d, 340e that are associated with the camera presets 320d, 320e are each shown outlined in dotted lines to denote their relationships to one another.

As described in the process 400 shown in FIG. 4, a user can configure one or more camera presets 320 that correspond to locations in the environment that one or more of the cameras 304a, 304b, 304c can be pointed towards, e.g., when a talker is sensed at the location of a camera preset 320. The process 400 can result in the allocation of cameras 304a, 304b, 304c to particular camera presets 320, and also the generation of error regions 340 associated with camera presets 320.

At step 402 of the process 400, the locations of camera presets 320 in the environment can be received from a user. The camera presets 320 may be associated with one of the microphone arrays 302a, 302b. For example, after the camera presets 320 are configured, when a talker is sensed by microphone array 302a, the location of the talker can be compared to the locations of camera presets 320a, 320b, 320c that are associated with microphone array 302a. If the location of the talker sensed by the microphone array 302a is determined to be at the location of one of the camera presets 320a, 320b, 320c, then the location of the talker may be transmitted to an aggregator unit (e.g., aggregator unit 104) and/or a camera controller (e.g., camera controller 106) to select and control one of the cameras 304a, 304b, 304c to be pointed at the location of the talker. The user can utilize an appropriate user interface to configure the locations of the camera presets 320 and the association of the camera presets 320 with a microphone array 302. The user interface may be associated with a suitable electronic device, such as a phone, computer, tablet, etc.

In embodiments, a desired size of the camera presets 320 can also be received from the user at step 402. The desired size of the camera presets 320 can be configurable to compensate for the acoustics of the room, such as to cause an overlap of one or more of the camera presets 320. The desired size may include, for example, a selection of narrow, medium, or wide, and/or may be defined in a specific unit and/or dimension.

At step 404, one or more of the cameras 304a, 304b, 304c may be allocated to a particular camera preset 320, based on the location of the camera presets 320 received at step 402. In some embodiments, the allocation of the cameras 304a, 304b, 304c may be determined automatically, and in other embodiments, the allocation of the cameras 304a, 304b, 304c may be performed by a user. In particular, the cameras 304a, 304b, 304c may be allocated to a camera preset 320 based on the distance between a camera 304 and a location of a camera preset 320, and/or based on an angle from a camera 304 to the location of the camera preset 320. For example, camera 304a may be allocated to camera preset 320b due to its relative closeness to camera preset 320b, while camera 304c may be allocated to camera preset 320a due to its alignment with camera preset 320a to result in a relatively narrower error region 340 for camera preset 320a due to the position of the microphone array 302a. The narrower error region 340 may enable the cameras 304a and/or 304c to further zoom in on a talker with greater accuracy.

Exemplary allocations 350, 352, 254 of the cameras 304 to camera presets 320 are shown in FIGS. 3A-3D by solid lines between the cameras 304 and camera presets 320. For example, camera 304a includes two camera presets 320a, 320b that are associated with microphone array 302a and one camera preset 320d that is associated with microphone array 302b. The camera 304a may have received allocations 350a, 350b for the corresponding camera presets 320a, 320b due to the relative position of the microphone array 302a to the location of the camera presets 320a, 320b. The camera 304a may have also received allocation 350d for the corresponding camera preset 320d due to the relative position of the microphone array 302a to the location of the camera preset 320d. Accordingly, depending on the orientation of the talker, when a microphone array 302 transmits a position of the talker to the aggregator unit and/or the camera controller, a corresponding camera 304 may be chosen that results in the best viewing angle of the talker. Moreover, depending on the camera 304 that is chosen, the pan and tilt for the camera 304 may be determined based on the position of the talker, and the zoom for the camera 304 may be determined based on the width of the error region 340 with respect to the camera 304.

Camera 304b includes one camera preset 320b that is associated with microphone array 302a and two camera presets 320d and 320e that are associated with microphone array 302b. The camera 304b may have received allocation 352b for corresponding camera preset 320b due to the relative position of the microphone array 302b to the location of the camera preset 320b. The camera 304b may have also received allocations 352d, 352e for the corresponding camera presets 320d, 320e due to the relative position of the microphone array 302b to the locations of the camera presets 320d, 320e. Camera 304c includes one camera preset 320a that is associated with microphone array 302a, and may have received allocation 354a for the corresponding camera preset 320a due to the relative position of the microphone array 302a to the location of the camera preset 320a.

At step 406, error regions 340 may be generated and adjusted based on the locations of the camera presets 320 and based on the positions and coverage areas of the microphone arrays 302. The error regions 340 may surround the locations of particular camera presets 320 to effectively act as an extension of each camera preset 320. In other words, the error regions 340 may compensate for the imprecise locations of talkers that may be determined by the microphone arrays 302 by being more flexible in determining if a location of a talker should be assumed to be at the location of a particular camera preset 320. The error regions 340 may vary in shape and size depending on the distance between a microphone array 302 and a location of a camera preset 320, and/or based on an angle between a microphone array 302 and the location of the camera preset 320. In embodiments, the microphone array 102, the camera controller 106, and/or the aggregator unit 104 may generate the error regions 340.

The error regions 340 for the camera presets 320 may be determined based on the room acoustics, the relative locations of furniture and other objects with respect to the microphone arrays 302 and a talker, and the inherent capability of the microphone arrays 302 to precisely measure azimuth, elevation, and radius of the position of a talker. For example, as shown in FIGS. 3A-3D, the error region 340a corresponds to camera preset 320a. However, in comparison, the error region 340e corresponding to camera preset 320e may be relatively larger than the error region 340a, due to, e.g., room acoustics. In embodiments, the error regions 340 may be user configured based on microphone array input as well as taking into consideration room reflections and acoustic situations for particular installation scenarios.

Exemplary error regions 340 are shown in FIGS. 3A-3D. In particular, an error region 340a surrounds camera preset 320a, and an error region 340b surrounds camera preset 320b. The error regions 340a, 340b may be associated with microphone array 302a since the camera presets 320a, 320b are associated with microphone array 302a. In addition, an error region 340d surrounds camera preset 320d, and an error region 340e surrounds camera preset 320e. The error regions 340d, 340e may be associated with microphone array 302b since the camera presets 320d, 320e are associated with microphone array 302b.

The error regions generated at step 406 may be stored at step 408 in a memory or database of the system 100. The generated error regions may also be displayed at step 408 to the user, such as displayed on the user interface that the user utilized to configure the locations of the camera presets 320 at step 402. As described in more detail below, the camera presets 320 and their associated error regions 340 can be utilized during automatic tracking of talkers to more optimally and accurately capture an image and/or video of an active talker in the environment.

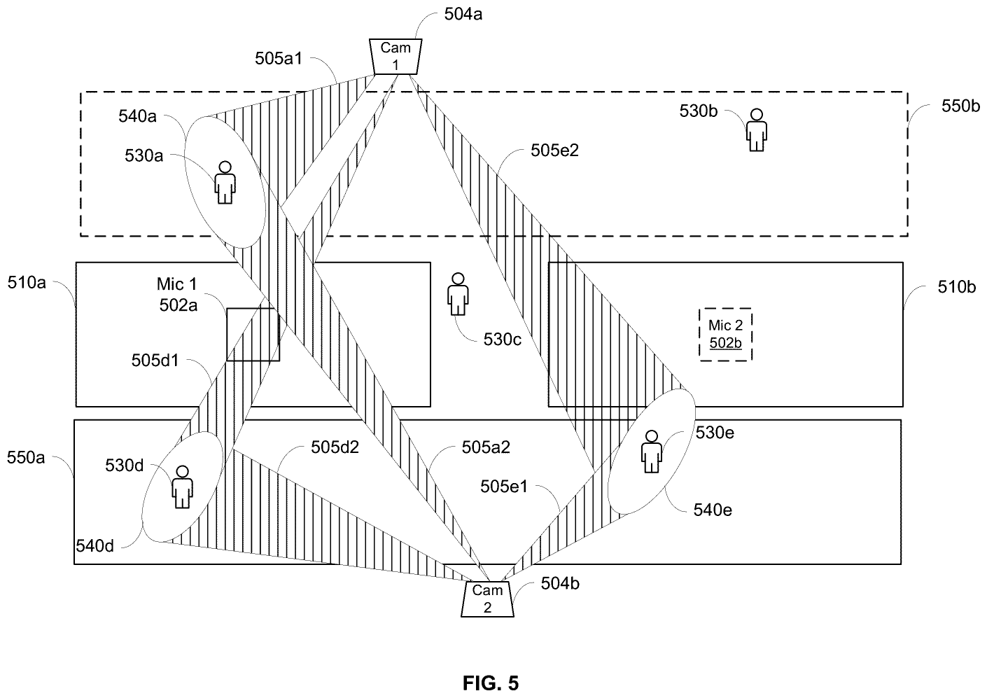

FIG. 5 is an exemplary top-down depiction of another environment in which the system and methods disclosed herein may be used. In particular, FIG. 5 shows an environment including two microphone arrays 502a, 502b (e.g., microphone array 200) and two cameras 504a, 504b. The environment shown in FIG. 5 also includes two tables 510a and 510b that could be located in a conference room and around which talkers may typically be seated, for example. As a non-limiting example, the microphone arrays 502a, 502b may be located on the ceiling of the room and the cameras 504a, 504b may be located on the walls of the room.

The environment shown in FIG. 5 includes two inclusion zones 550a, 550b. The inclusion zones may be user-defined areas where a camera 504 can be configured to automatically track a talker, based on the location of the talker as determined by the microphones 502. The automatic tracking of talkers is described in more detail below with respect to the process 700 shown in FIG. 7. As shown outlined in solid lines in FIG. 5, the inclusion zone 550a may be associated with microphone array 502a. Similarly, as shown outlined in dotted lines in FIG. 5, the inclusion zone 550b may be associated with microphone array 502b.

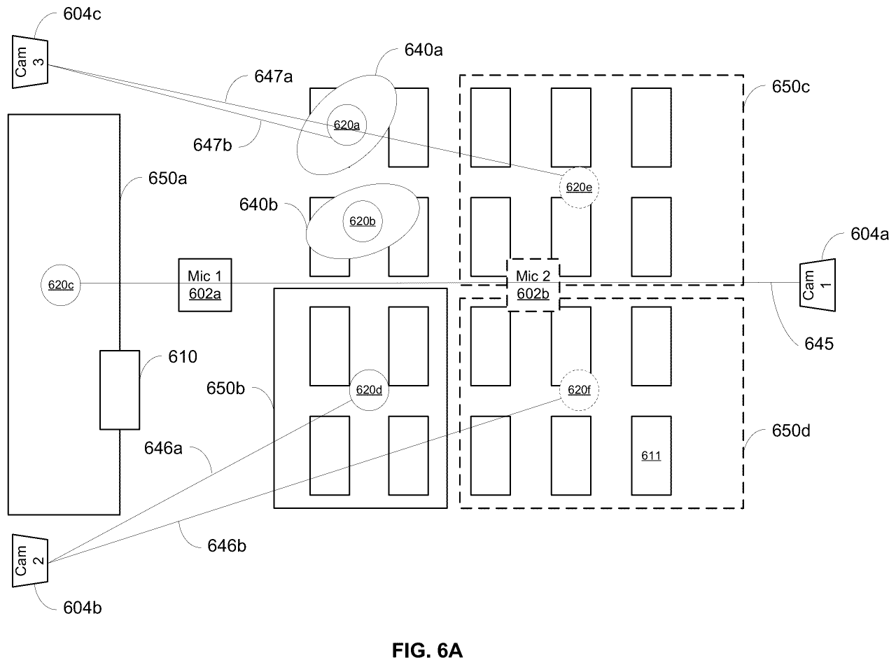

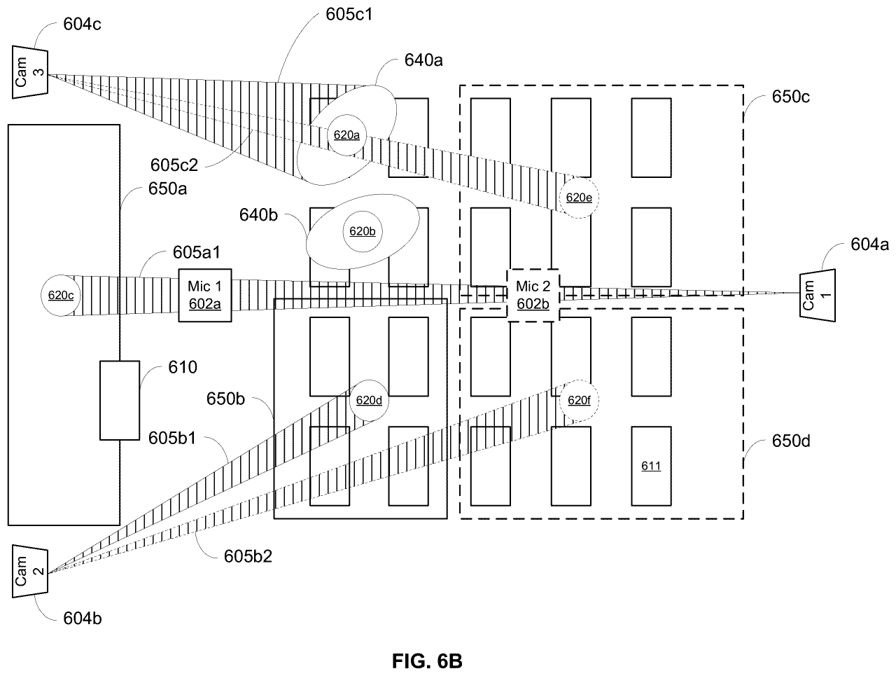

FIGS. 6A-6B are exemplary top-down depictions of a further environment in which the system and methods disclosed herein may be used. In particular, each of FIGS. 6A-6B shows an environment including two microphone arrays 602a, 602b (e.g., microphone array 200) and three cameras 604a, 604b, 604c. The environment shown in FIGS. 6A-6B may be, for example, a classroom setting with a lectern 610 (e.g., the rectangle where a teacher may be located on the left side of FIGS. 6A-6B) and desks 611 (e.g., the rectangles where students may be located on the center and right side of FIGS. 6A-6B). As a non-limiting example, the microphone arrays 602a, 602b may be located on the ceiling of the classroom and the cameras 604a, 604b, 604c may be located on the wall of the classrooms.

The environment shown in FIGS. 6A-6B includes camera presets 620 that may be associated with each of the microphone arrays 602. In particular, the camera presets 620a, 620b, 620c, 620d may each be associated with the microphone array 602a, as shown outlined in solid lines. In addition, the camera preset 620a may be associated with an error region 640a and the camera preset 620b may be associated with an error region 640b. Similarly, the camera presets 620e, 620f may each be associated with the microphone array 602b, as shown outlined in dotted lines. The camera presets 620 and error regions 640 may have been configured using the process 400 described above, for example.

Exemplary allocations 645, 646, 647 of the cameras 604 to camera presets 620 are shown in FIG. 6A by the solid lines between the cameras 604 and camera presets 620. For example, camera 604a includes a camera preset 620c that is associated with microphone array 602a, and may have received allocation 645 for corresponding camera preset 620c due to the relative position of microphone array 602a to the location of camera preset 620c. Camera 604b includes a camera preset 620d associated with microphone array 602a and a camera preset 620f that is associated with microphone array 602b. The camera 604b may have received allocation 646a for corresponding camera preset 620d due to the relative position of microphone array 602a to the location of camera preset 620d, and allocation 646b for corresponding camera preset 620f due to the relative position of microphone array 602b to the location of camera preset 620f. Camera 604c includes camera presets 620a, 620e associated with microphone array 602a, and may have received allocations 647a, 647b for the corresponding camera presets 620a, 620e due to the relative position of the microphone array 602a to the locations of the camera presets 620a, 620e.

The environment of FIGS. 6A-6B may also include inclusion zones 650 that are associated with the microphone array 602. For example, the microphone array 602a may be associated with inclusion zones 650a, 650b, and the microphone array 602b may be associated with inclusion zones 650c, 650d. Accordingly, the environment shown in FIGS. 6A-6B may include aspects of the environment shown in FIGS. 3A-3D (having camera presets and error regions) and the environment shown in FIG. 5 (having inclusion zones). It should be noted that fields of view of the various cameras 304, 504, 604 in FIGS. 3A-3D, FIG. 5, and FIG. 6B are depicted by vertically-lined regions.

As described in the process 700 shown in FIG. 7, talkers in an environment can be detected by microphone arrays and be automatically tracked so that cameras in the environment can capture images and/or video of the talker. For example, when a talker is sensed by a microphone array at the location of a camera preset or within an error region of a camera preset, a camera allocated to the camera preset and/or the error region can be controlled to point towards the talker. As another example, when a talker is sensed by a microphone array within an inclusion zone of an environment, a camera can be controlled to point towards the talker.

At step 702 of the process 700, the location of a talker in an environment can be determined, such as by a microphone array 302, 502, 602. For example, an audio activity localizer in the microphone array 302, 502, 602 may execute an audio localization algorithm to determine the location of the talker by sensing audio activity, e.g., speech, from the talker. For example, in FIG. 5, potential talkers 530 are shown in the environment, and specifically, talkers 530a, 530d, and 530e may be active talkers whose locations are sensed at step 702.

At step 704, it may be determined whether any camera presets have been configured, such as camera presets 320, 620 that have been configured by a user using the process 400 described previously. If it is determined at step 704 that camera presets have been configured (“YES”), then the process 700 may continue to step 706. At step 706, it may be determined whether the location of the talker determined at step 702 is at the location of one of the camera presets 320, 620 and/or within an error region associated with one of the camera presets 320, 620. If it is determined at step 706 that the location of the talker is at a camera preset and/or within an error region (“YES”), then the process 700 may continue to step 710. At step 710, a camera 304, 604 that is allocated to the particular camera preset may be selected. In addition, the selected camera 304 can be controlled at step 710 to point towards the location of the talker. Controlling the selected camera 304 at step 710 may include moving and/or zooming the selected camera 304 such that the selected camera 304 includes a suitable portion of the error region to capture the talker within the frame of the selected camera 304. In embodiments, the amount of zoom that is applied at step 710 may be based on the error region and the selected allocated camera 304.

For example, in the environment shown in FIG. 3A, a location of a talker may be at the camera preset 320a and/or within the error region 340a associated with the camera preset 320a. In this scenario, camera 304a or camera 304c may be selected at step 710 to point towards the location of the talker, as denoted by the allocations 350a, 354a, respectively. If camera 304a is selected, the image and/or video captured by the camera 304a may be at a wide angle as shown by a field of view 305a1 in FIG. 3A, due to the distance and angle of the camera 304a with respect to the microphone array 302a that is associated with the camera preset 320a and error region 340a. However, if the camera 304c is selected, the image and/or video captured by the camera 304c may be zoomed in on the talker because the camera 304c is aligned with the microphone array 302a and corresponding error region 340a, as shown by a field of view 305a2 in FIG. 3A.

Similar examples are shown in FIGS. 3B, 3C, and 3D for camera presets 320b, 320d, and 320e, respectively. In particular, in the environment shown in FIG. 3B, a location of a talker may be at the camera preset 320b and/or within the error region 340b associated with the camera preset 320b. In this scenario, camera 304a or camera 304b may be selected at step 710 to point towards the location of the talker, as denoted by the allocations 350b, 352b, respectively. If camera 304a is selected, the image and/or video captured by the camera 304a may be at a relatively narrow angle as shown by a field of view 305b1 in FIG. 3B, due to the distance and angle of the camera 304a with respect to the microphone array 302a that is associated with the camera preset 320b and error region 340b. However, if the camera 304b is selected, the image and/or video captured by the camera 304b may a relatively wider view of the talker, as shown by a field of view 305b2 in FIG. 3B.

In the environment shown in FIG. 3C, a location of a talker may be at the camera preset 320d and/or within the error region 340d associated with the camera preset 320d. In this scenario, camera 304a or camera 304b may be selected at step 710 to point towards the location of the talker, as denoted by the allocations 350d, 352d, respectively. If camera 304a is selected, the image and/or video captured by the camera 304a may be at a relatively wide angle as shown by a field of view 305d1 in FIG. 3C, due to the distance and angle of the camera 304a with respect to the microphone array 302b that is associated with the camera preset 320d and error region 340d. However, if the camera 304b is selected, the image and/or video captured by the camera 304b may be a relatively narrow view of the talker, as shown by a field of view 305d2 in FIG. 3C.

In the environment shown in FIG. 3D, a location of a talker may be at the camera preset 320e and/or within the error region 340e associated with the camera preset 320e. In this scenario, camera 304b may be selected at step 710 to point towards the location of the talker, as denoted by the allocation 352e. By selecting and using camera 304b, the image and/or video captured by the camera 304b may be at a relatively wide angle as shown by a field of view 305e1 in FIG. 3D, due to the distance and angle of the camera 304b with respect to the microphone array 302b that is associated with the camera preset 320e and error region 340e.

Returning to step 704, if it is determined that camera presets have not been configured (“NO”), then the process 700 may continue to step 708. At step 708, it may be determined whether the location of the talker determined at step 702 (e.g., a talker 530 of FIG. 5) is within an inclusion zone (e.g., inclusion zones 550, 650) in the environment. If it is determined that the location of the talker is within an inclusion zone at step 708 (“YES”), then the process 700 may continue to step 709. At step 709, an error region may be dynamically generated based on the location of the talker and based on the positions and coverage areas of the microphone arrays. For example, as shown in FIG. 5, an error region 540a may be generated for active talker 530a, an error region 540d may be generated for active talker 530d, and an error region 540e may be generated for active talker 530e.

At step 710, a camera allocated to the inclusion zone where the talker is located may be selected. The selected camera may be controlled to point towards the location of the talker at step 710, and the camera may also be configured to include the corresponding error region defined by the microphone array for the particular location of the talker.

For example, in the environment shown in FIG. 5, a location of an active talker 530a may be within inclusion zone 550b that is associated with microphone array 502b. In this scenario, either camera 504a or camera 504b may be selected at step 710 to point towards the location of the active talker 530a. The selection of the camera 504a or the camera 504b may be based on the position and/or angle of the talker with respect to a particular camera. As shown in FIG. 5, if camera 504a is selected at step 710, camera 504a may be controlled to use a relatively wider angle for active talker 530a, as shown by the field of view 505a1 associated with camera 504a that is based on the error region 540a. Camera 504b may alternatively be selected at step 710 so that camera 504b is controlled to zoom in and have a better close-up of active talker 530a due to the relatively narrower angle from camera 504b, as shown by the field of view 505a2.

As another example, the location of active talker 530d may be within inclusion zone 550a that is associated with microphone array 502a. Camera 504a may be selected at step 710 to point towards the location of the active talker 530d. As shown by the field of view 505d1 in FIG. 5, camera 504a may be controlled at step 710 to zoom in relatively tightly on active talker 530d. Alternatively, camera 504b may be selected and controlled at step 710 to point toward the location of the active talker 530d as shown by the field of view 505d2 in order to have a relatively wider angle of the active talker 530d.

As a further example, the location of active talker 530e may also be within inclusion zone 550a. Camera 504b may be selected at step 710 to point towards the location of the active talker 530e. Camera 504b may be controlled at step 710 to use the field of view 505e1 shown in FIG. 5 to capture images and/or video of the active talker 530e. Alternatively, camera 504a may be selected and controlled at step 710 to point toward the location of the active talker 530e as shown by the field of view 505e2 in order to have a relatively wider angle view of the active talker 530e. Regardless, as a talker moves within the inclusion zone 550b, the selected camera 504a, 504b may move and/or zoom to automatically track the talker, or the other camera 504b, 504a may be selected to point and/or zoom towards the talker.

As another example, in the environment shown in FIG. 6B, when a particular camera 604a, 604b, and 604c is selected, its pan, tilt, and/or zoom can be adjusted so that an active talker can be captured when the active talker is located at a camera preset 620 and/or within an inclusion zone 650. In particular, the camera 604a may have a field of view 605a1 that captures and zooms in on an active talker located at camera preset 620c. The camera 604b may be adjusted to point towards and/or zoom in on active talkers located at the camera presets 620d, 620f with associated fields of view 605b1, 605b2, respectively. The camera 604c may be adjusted based on the error regions 640a, 640b for corresponding camera presets 620a, 620b such that there are associated fields of view 650c1, 650c2, respectively. Furthermore, in the case of an active talker in inclusion zones 650c or 650d, the pan, tilt, and/or zoom of the cameras 604 may be adjusted to optimally cover the active talker in those zones, based on the error regions for the location of the talker.

If it is determined at step 708 that the location of the talker is not within an inclusion zone (“NO”), then the process 700 may return to step 702 to determine the location of talkers. The process 700 may also return to step 702 if at step 706, it is determined that the location of the talker is not at a camera preset and/or not within an error region (“NO”).

The description herein describes, illustrates and exemplifies one or more particular embodiments of the invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the invention is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose. As stated above, the specification is intended to be taken as a whole and interpreted in accordance with the principles of the invention as taught herein and understood to one of ordinary skill in the art.

Any process descriptions or blocks in figures should be understood as representing modules, segments, or portions of code which include one or more executable instructions for implementing specific logical functions or steps in the process, and alternate implementations are included within the scope of the embodiments of the invention in which functions may be executed out of order from that shown or discussed, including substantially concurrently or in reverse order, depending on the functionality involved, as would be understood by those having ordinary skill in the art.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) were chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the embodiments as determined by the appended claims, as may be amended during the pendency of this application for patent, and all equivalents thereof, when interpreted in accordance with the breadth to which they are fairly, legally and equitably entitled.

1. A method, comprising:
receiving a location of a camera preset;
determining a camera of a conferencing system to be associated with the location of the camera preset, based on: the location of the camera preset, a location of a microphone, and a location of the camera;
determining an error region associated with the camera preset, based on: the location of the camera preset, the location of the microphone, and a coverage area of the microphone; and
storing the error region associated with the camera preset.

2. The method of claim 1, wherein the error region associated with the camera preset comprises an area surrounding the location of the camera preset.

3. The method of claim 1, further comprising receiving a size of the camera preset, and wherein determining the error region comprises determining the error region further based on the size of the camera preset.

4. The method of claim 1, wherein determining the error region comprises determining the error region based on a distance between the location of the microphone and the location of the camera preset.

5. The method of claim 1, wherein determining the error region comprises determining the error region based on an alignment of the camera with the microphone.

6. The method of claim 1, wherein determining the error region comprises determining the error region based on acoustics of an environment where the microphone is located.

7. The method of claim 1, wherein determining the error region comprises determining the error region based on a physical configuration of an environment where the microphone is located.

8. The method of claim 1, further comprising displaying the error region and the location of the camera preset on a display in communication with the conferencing system.

9. The method of claim 1, wherein determining the error region is further based on a configuration received from a user interface in communication with the conferencing system.

10. A method, comprising:
retrieving a stored error region associated with a camera preset;
determining, using a microphone and based on audio associated with a talker, a location of the talker;
selecting, based on the location of the talker and the error region associated with the camera preset, a camera for capturing an image of the talker; and
transmitting the location of the talker to the camera to cause the camera to point towards the location of the talker.

11. The method of claim 10, wherein the error region associated with the camera comprises an area surrounding the location of the camera preset.

12. The method of claim 10, further comprising determining whether the camera preset has been configured, and when it is determined that the camera preset has been configured, performing the steps of selecting the camera and transmitting the location of the talker to the camera.

13. The method of claim 10, further comprising determining whether the location of the talker is within the error region, and when it is determined that the location of the talker is within the error region, performing the steps of selecting the camera and transmitting the location of the talker to the camera.

14. The method of claim 10, further comprising determining whether the location of the talker is within an inclusion zone associated with the microphone, and when it is determined that the location of the talker is within the inclusion zone, performing the steps of selecting the camera and transmitting the location of the talker to the camera.

15. The method of claim 14, wherein the inclusion zone comprises a user-defined area in an environment where the camera is configured to automatically track the talker, based on the location of the talker determined by the microphone.

16. The method of claim 14, further comprising when it is determined that the location of the talker is within the inclusion zone, determining the error region based on: the location of the talker, the location of the microphone, and a coverage area of the microphone.

17. The method of claim 16, wherein determining the error region comprises determining the error region based on acoustics of an environment where the microphone is located.

18. The method of claim 16, wherein determining the error region comprises determining the error region based on a physical configuration of an environment where the microphone is located.

19. The method of claim 10, wherein determining the location of the talker comprises determining the location of the talker by processing the audio associated with the talker with an audio localization algorithm.

20. A system, comprising:
a plurality of microphones, each of the plurality of microphones having a location and a coverage area;
a plurality of cameras, each of the plurality of cameras having a location; and
one or more processors in communication with the plurality of microphones and the plurality of cameras, any of the one or more processors configured to:
determine one of the plurality of cameras to be associated with a camera preset, based on: the location of the camera preset, the location of one of the plurality of microphones, and the location of the one of the plurality of cameras;
determine an error region associated with the camera preset, based on: the location of the camera preset, the location of the one of the plurality of microphones, and the coverage area of the one of the plurality of microphones; and
when a location of a talker is determined to be within the error region associated with the camera preset, select and control the one of the plurality of cameras to capture an image of the talker.
